(19) United States
(12) Patent Application Publication
(10) Pub. No.: US 2024/0412101 A1
(43) Pub. Date: Dec. 12, 2024

(54) Predicting a Suspension Time Period Using Artificial Intelligence

(71) Applicant: Saudi Arabian Oil Company, Dhahran (SA)

(72) Inventors: Abdulmajeed M. Alotaibi, Udhailiyah (SA); Ahmed Bassam Al-Arnous, Udhailiyah (SA); Abdullah M. Bin Ziad, Dhahran (SA)

(21) Appl. No.: 18/332,205

(22) Filed: Jun. 9, 2023

(51) Int. Cl. G06N 20/00

(52) U.S. Cl. CPC G06N 20/00

(57) ABSTRACT

A computer-implemented method for generating training samples via 3D modeling for machine learning-based greenhouse gas emission detection is described. The method includes obtaining historical data associated with operational suspension events corresponding to respective locations. The method also includes training a machine learning model to predict a suspension time period using a training dataset comprising the historical data associated with operational suspension events. Additionally, the method includes predicting a suspension time period corresponding to a location using the trained machine learning model.

### TECHNICAL FIELD

This disclosure relates generally to predicting a suspension time period.

### BACKGROUND

Oil and gas operations are exposed to weather conditions that can hinder the performance of various tasks associated with oil and gas operations. To ensure the safety of personnel, equipment, and the environment, oil and gas operations are suspended in the presence of adverse weather conditions.

### SUMMARY

An embodiment described herein provides a method for predicting a suspension time period using artificial intelligence. The method includes obtaining, using at least one hardware processor, historical data associated with operational suspension events corresponding to respective locations. The method also includes training, using at least one hardware processor, a machine learning model to predict a suspension time period using a training dataset comprising the historical data associated with operational suspension events. Additionally, the method includes predicting, using the at least one hardware processor, a suspension time period corresponding to a location using the trained machine learning model.

An embodiment described herein provides an apparatus comprising a non-transitory, computer readable, storage medium that stores instructions that, when executed by at least one processor, cause the at least one processor to perform operations. The operations include obtaining historical data associated with operational suspension events corresponding to respective locations. The operations also include training a machine learning model to predict a suspension time period using a training dataset comprising the historical data associated with operational suspension events. Additionally, the operations include predicting a suspension time period corresponding to a location using the trained machine learning model.

An embodiment described herein provides a system. The system comprises one or more memory modules and one or more hardware processors communicably coupled to the one or more memory modules. The one or more hardware processors is configured to execute instructions stored on the one or more memory models to perform operations. The operations include obtaining historical data associated with operational suspension events corresponding to respective locations. The operations also include training a machine learning model to predict a suspension time period using a training dataset comprising the historical data associated with operational suspension events. Additionally, the operations include predicting a suspension time period corresponding to a location using the trained machine learning model.

In some embodiments, the training dataset comprises historical suspension time periods labeled by respective dates and respective locations.

In some embodiments, the training dataset comprises historical suspension time periods and corresponding weather conditions.

In some embodiments, the trained machine learning model is evaluated by determining the mean absolute percentage error (MAPE) of the trained machine learning model, and re-training the trained machine learning model when the MAPE satisfies a predetermined threshold.

In some embodiments, oil and gas operations are planned based on the predicted suspension time period.

In some embodiments, lifting tasks in oil and gas operation planning are avoided during the predicted suspension time period.

In some embodiments, the historical data is pre-processed.

### BRIEF DESCRIPTION OF DRAWINGS

FIG. 1 is a workflow for predicting a suspension time period using artificial intelligence.

FIG. 2 is a process flow diagram of a method that enables predicting a suspension time period using artificial intelligence.

FIG. 3 is a schematic illustration of an example controller for predicting a suspension time period using artificial intelligence according to the present disclosure.

### DETAILED DESCRIPTION

Weather conditions impact oil and gas operations, since a large portion of the oil and gas operations are performed outdoors with limited protection from weather conditions. For example, rigs are large structures used for various oil and gas operations, such as drilling and workovers. Further, rigs are used at various locations, and can be onshore or offshore. Additionally, rigs can be fixed (e.g., directly attached to the earth for long term use) or mobile, such as floating rigs. Adverse weather conditions can damage rigs and pose a safety risk to rig operators and the environment.

Embodiments described herein enable prediction of a suspension time period using artificial intelligence. In some embodiments, historical data associated with an operational suspension time period is obtained. A training dataset is generated that includes the historical data. In examples, the historical data is pre-processed and is labeled with a corresponding month and location. A machine learning model is trained to predict a suspension time period corresponding to a location using the trained machine learning model. The predicted suspension time period enables avoidance of oil and gas planning and schedules that result in operational hinders. For example, rig-based operations are avoided at locations during time periods that are associated with operational suspensions. This improves on the ultimate performance of an organization (i.e. business continuity, financially, etc.), as business hinders are avoided. Additionally, weather conditions that might lead to operational suspension as a matter of safety are avoided. In examples, the predicted suspension time period is used to avoid scheduling and executing of well completion and intervention operations, such as lifting jobs (i.e. jobs using crane) such as coil tubing, and wireline.

Well completion and intervention operations are suspended when the wind speed exceeds a certain limit. Accordingly, the machine learning model according to the present techniques enables proper planning and avoids business hinder based on historical data of operational suspension events including the suspension duration time (hrs.), and corresponding month and location.

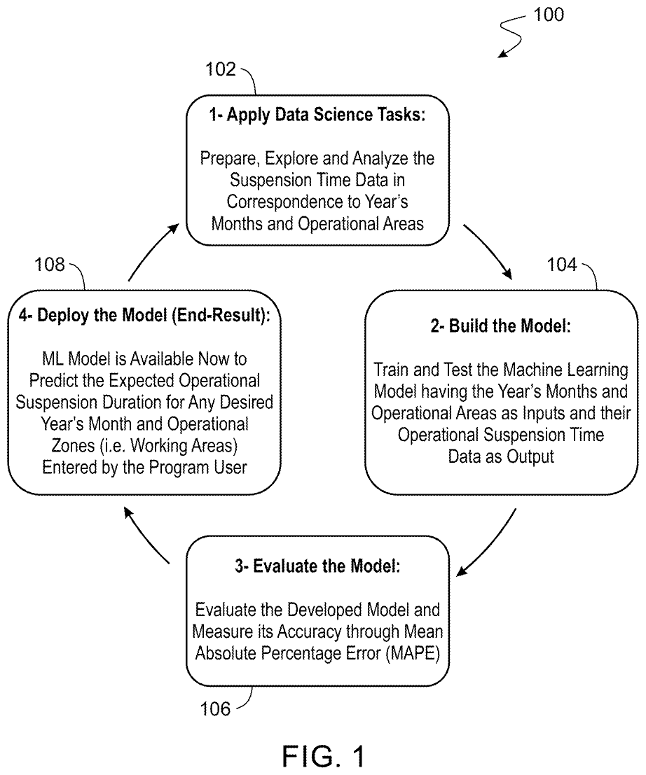

FIG. 1 is a workflow 100 for predicting a suspension time period using artificial intelligence. In examples, the workflow 100 obtains historical data associated with at least one operational area (e.g., a location where operations are performed). A machine learning model is trained, evaluated, and deployed.

At block 102, data science tasks are applied to the historical data. The historical data includes, for example, suspension time period data associated with an operational area. In some embodiments, the historical data includes weather conditions and corresponding time periods where operations are suspended (e.g., suspension time period data) at an operational area. In examples, an operational area refers to an oil and gas field, a geographic location, or other positional identifiers associated with a real world location. In examples, the suspension time period is a duration of time where operations are stopped. The duration may be expressed in units of time such as seconds, minutes, hours, days, and the like. In examples, the suspension time period is defined by beginning and ending points in time, such as a particular second, minute, hour, or day that begins the suspension time period and a particular second, minute, hour, or day that ends the suspension time period.

In examples, the historical data is pre-processed by applying data science tasks including various tools, data mining, statistical techniques, algorithms and machine learning principles to identify trends, patterns and insights from raw historical data. For example, the suspension time period data is prepared, explored, and analyzed. In examples, the suspension time period data expressed in units of time is labeled according to the respective date, such as the month of the year. In examples, the suspension time period data is labeled according to a respective location, such as the real world coordinates or location of a respective oil and gas field.

In some embodiments, data science tasks including data acquisition, preparation, cleaning, visualization, and analysis are applied to the historical data to build a reliable model that predicts the suspension time period using a specified month and location as inputs. In some embodiments, the model predicts weather conditions using a specified month and location as inputs. For ease of explanation, the suspension time period is expressed as a number of hours during a one month period. However, the suspension time period may be expressed in any unit of time. In examples, data cleaning includes correcting missing or incomplete data. Data cleaning also includes removing duplicate or inconsistent data. In examples, the data is prepared by normalizing the data. Data normalization transforms the data so that it lies within a predetermined range or distribution. In examples, pre-processing the data includes feature extraction to select relevant features from the dataset that the model learns during training. Additionally, in some embodiments, pre-processing the data includes dimensionality reduction that compresses the features in the data to a lower-dimensional space. In examples, the historical data is pre-processed and split into training and testing datasets. The historical data includes weather conditions, the corresponding operational suspension time period, the corresponding month and location, or any combinations thereof.

At block 104, a machine learning model is built. In examples, the machine learning model is built by selecting a machine learning model algorithm and training the selected machine learning model algorithm to obtain a trained machine learning model. In examples, the machine learning model is based on an algorithm such as a decision tree, neural network (e.g., multilayer perceptron), Support-Vector Machine

(SVM), linear regression, logistic regression, Naive Bayes, linear discriminant analysis, K-nearest neighbor, similarity learning, or any combinations thereof.

In some embodiments, supervised learning is used to train the machine learning model. The supervised learning establishes a relationship between operational suspension time periods and the month and location. In examples, the machine learning model is trained using 4,678 data pairs including (1) operational suspension time period and (2) the corresponding month and location. In examples, the machine learning model is trained using the training datasets. A month of the year and location are input to a trained machine learning model, and the trained machine learning model outputs a predicted suspension time period. Additionally, in examples, supervised learning establishes a relationship between weather conditions, operational suspension time periods, and the month and location. For example, a month of the year and location are input to a trained machine learning model, and the trained machine learning model outputs predicted weather conditions and/or a predicted suspension time period.

At block 106, the trained model is evaluated. In examples, evaluating the trained machine learning model includes evaluating the trained model using a testing dataset. The accuracy of the trained machine learning model is measured by determining the mean absolute percentage error (MAPE) of the trained machine learning model. The MAPE measures an accuracy of predictions made by forecasting. In examples, the MAPE is used as a loss function in evaluating the trained machine learning model. The trained machine learning model is retrained until the loss function is minimized below a predetermined threshold. In examples, the trained machine learning model is iteratively re-trained until the MAPE satisfies a predetermined threshold.

At block 108, the trained machine learning model is deployed. In

examples, the trained machine learning model is deployed when the MAPE satisfies a predetermined threshold. For example, when the MAPE is below a predetermined threshold, the trained machine learning model is deployed. In examples, deploying a trained machine learning model refers to the implementation of the trained machine learning model in a real world application. In the real world application, unseen data is input to the trained machine learning model, and the trained machine learning model outputs a predicted suspension time period. Upon deployment, the trained machine learning model is available to predict the expected operational suspension time period at location for a month of the year. In examples, a user interface is used to obtain the location and month of the year as input. In examples, the user interface displays the operational suspension time period as output by the trained machine learning model. For example, the user interface outputs a number of hours that is the predicted operational suspension time period corresponding to the input location and month of the year. Additionally, in examples, a user interface is used to obtain the location and month of the year as input and the user interface displays the weather conditions and operational suspension time period as output by the trained machine learning model. For example, the user interface outputs predicted weather conditions and the predicted operational suspension time period corresponding to the input location and month of the year.

In examples, as additional historical data becomes available, the model is retrained using the additional historical data. The trained machine learning model according to the present techniques enables proper planning, cost effectiveness, and safer operations through forecasting the ability to conduct jobs or operations that include excessive lifting tasks (i.e. coil tubing, wireline, fishing, etc.) at specified locations per each month of the year. In examples, the predicted suspension of time duration for at least one month is obtained prior to planning well completion operations. For example, the location and a future time period are input to a trained machine learning model. The trained machine learning model predicts the suspension time period for each month within a future time period. In examples, the predicted suspension time period for each month is used to plan operations. For example, the predicted suspension time period can govern the type and volume of work planned for each month during the future time period.

In some embodiments, the present techniques use weather predictions to mitigate rigless operations risks in oil and fields. In some embodiments, artificial intelligence is used to predict weather conditions in rigless operations. The predicted conditions are used to mitigate rigless operations risk in oil and fields. For example, the location and a future time period are input to a trained machine learning model. The trained machine learning model predicts the weather conditions and suspension time period for each month within the future time period. In examples, the predicted suspension time period for each month is used to plan operations. For example, the predicted weather conditions and suspension time period can govern the type and volume of work planned for each month during the future time period.

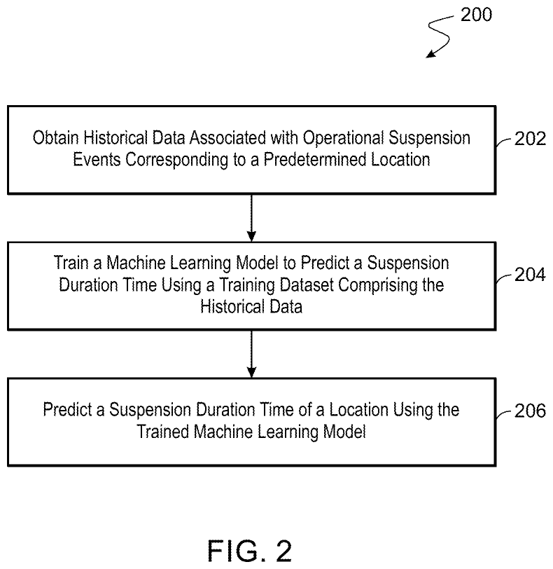

FIG. 2 is a process flow diagram of a method that enables predicting a suspension time period using artificial intelligence. In some embodiments, the machine learning models are trained and deployed as described with respect to FIG. 1.

At block 202, historical data associated with operational suspension events is obtained. In examples, the operational suspension events correspond to at least one operational suspension time period at a predetermined location. In examples, the historical data is pre-processed. Pre-processing the historical data includes applying data mining, statistical techniques, algorithms and machine learning principles to identify trends, patterns and insights from raw historical data.

At block 204, a machine learning model is trained to predict a suspension time period corresponding to a location and month using a training dataset comprising the historical data obtained at block 202. In examples, the training dataset comprises historical suspension time periods times labeled by respective dates and locations. In examples, the training dataset comprises historical suspension time periods and corresponding weather conditions. Accordingly, in some embodiments the machine learning model is trained to predict weather conditions and a suspension time period according to a location and month using a training dataset comprising the historical data obtained at block 202. In some embodiments, the trained machine learning model is evaluated by determining the mean absolute percentage error (MAPE) of the trained machine learning model, and re-training the trained machine learning model until the MAPE satisfies a predetermined threshold.

At block 206, a suspension time period corresponding to a location is predicted using the trained machine learning model. In some embodiments, weather conditions and a suspension time period corresponding to a location is predicted using the trained machine learning model. Accordingly, the machine learning models are trained to make predictions (e.g., outputs). In examples, machine learning models are trained using a training dataset. The machine learning model makes decisions and learns from the dataset. Once trained, the machine learning model can make decisions in response to unseen data, and make predictions about the unseen data. In some embodiments, oil and gas operations are scheduled or planned based on the predictions. For example, lifting tasks in oil and gas operations are avoided during the predicted weather conditions that are adverse to such tasks. In another example, lifting tasks in oil and gas operations are avoided during months where the predicted suspension time periods fails to satisfy a predetermined threshold. The predetermined threshold is based on the duration of time needed to complete a particular task. In examples, scheduling a lifting task that takes fifty hours to complete is avoided for weeks or months when the predicted suspension time periods prevent the scheduling of fifty hours without a suspension time period to complete the lifting task.

Further, in examples weather conditions associated with the location are input into the trained machine learning model. For example, the machine learning model is trained to predict suspension time periods based on weather conditions. In examples, oil and gas operations are scheduled to avoid adverse weather conditions based on the predicted suspension time periods.

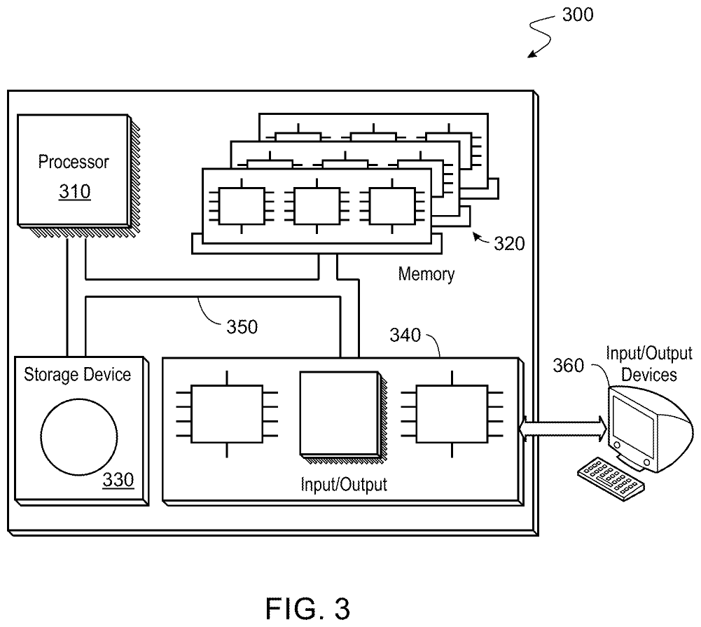

FIG. 3 is a schematic illustration of an example controller 300 (or control system) for predicting a suspension time period using artificial intelligence according to the present disclosure. For example, the controller 300 may be operable according to the process 200 of FIG. 2, using the workflow 100 of FIG. 1. The controller 300 is intended to include various forms of digital computers, such as printed circuit boards (PCB), processors, digital circuitry, or otherwise parts of a system for supply chain alert management. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 300 includes a processor 310, a memory 320, a storage device 330, and an input/output interface 340 communicatively coupled with input/output devices 360 (for example, displays, keyboards, measurement devices, sensors, valves, pumps). Each of the components 310, 320, 330, and 340 are interconnected using a system bus 350. The processor 310 is capable of processing instructions for execution within the controller 300. The processor may be designed using any of a number of architectures. For example, the processor 310 may be a CISC (Complex Instruction Set Computers) processor, a RISC (Reduced Instruction Set Computer) processor, or a MISC (Minimal Instruction Set Computer) processor.

In one implementation, the processor 310 is a single-threaded processor. In another implementation, the processor 310 is a multi-threaded processor. The processor 310 is capable of processing instructions stored in the memory 320 or on the storage device 330 to display graphical information for a user interface on the input/output interface 340.

The memory 320 stores information within the controller 300. In one implementation, the memory 320 is a computer-readable medium. In one implementation, the memory 320 is a volatile memory unit. In another implementation, the memory 320 is a nonvolatile memory unit.

The storage device 330 is capable of providing mass storage for the controller 300. In one implementation, the storage device 330 is a computer-readable medium. In various different implementations, the storage device 330 may be a floppy disk device, a hard disk device, an optical disk device, or a tape device.

The input/output interface 340 provides input/output operations for the controller 300. In one implementation, the input/output devices 360 includes a keyboard and/or pointing device. In another implementation, the input/output devices 360 includes a display unit for displaying graphical user interfaces.

There can be any number of controllers 300 associated with, or external to, a computer system containing controller 300, with each controller 300 communicating over a network. Further, the terms “client,” “user,” and other appropriate terminology can be used interchangeably, as appropriate, without departing from the scope of the present disclosure. Moreover, the present disclosure contemplates that many users can use one controller 300 and one user can use multiple controllers 300.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware-and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a key board and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship. Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

Particular embodiments of the subject matter have been described. Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

What is claimed is:

1. A computer-implemented method for predicting weather risk using artificial intelligence, the method comprising:
obtaining, using at least one hardware processor, historical data associated with operational suspension events corresponding to respective locations:
training, using at least one hardware processor, a machine learning model to predict a suspension time period using a training dataset comprising the historical data associated with operational suspension events; and
predicting, using the at least one hardware processor, a suspension time period corresponding to a location using the trained machine learning model.

2. The computer implemented method of claim 1, wherein the training dataset comprises historical suspension time periods labeled by respective dates and respective locations.

3. The computer implemented method of claim 1, wherein the training dataset comprises historical suspension time periods and corresponding weather conditions.

4. The computer implemented method of claim 1, comprising evaluating the trained machine learning model by determining a mean absolute percentage error (MAPE) of the trained machine learning model, and re-training the trained machine learning model when the MAPE satisfies a predetermined threshold.

5. The computer implemented method of claim 1, comprising planning oil and gas operations based on the predicted suspension time period.

6. The computer implemented method of claim 1, comprising avoiding lifting tasks in oil and gas operation planning during the predicted suspension time period.

7. The computer implemented method of claim 1, wherein the historical data is pre-processed.

8. An apparatus comprising a non-transitory, computer readable, storage medium that stores instructions that, when executed by at least one processor, cause the at least one processor to perform operations comprising:
obtaining historical data associated with operational suspension events corresponding to respective locations:
training a machine learning model to predict a suspension time period using a training dataset comprising the historical data associated with operational suspension events; and
predicting a suspension time period corresponding to a location using the trained machine learning model.

9. The apparatus of claim 8, wherein the training dataset comprises historical suspension time periods labeled by respective dates and respective locations.

10. The apparatus of claim 8, wherein the training dataset comprises historical suspension time periods and corresponding weather conditions.

11. The apparatus of claim 8, comprising evaluating the trained machine learning model by determining a mean absolute percentage error (MAPE) of the trained machine learning model, and re-training the trained machine learning model when the MAPE satisfies a predetermined threshold.

12. The apparatus of claim 8, comprising planning oil and gas operations based on the predicted suspension time period.

13. The apparatus of claim 8, comprising avoiding lifting tasks in oil and gas operation planning during the predicted suspension time period.

14. The apparatus of claim 8, wherein the historical data is pre-processed.

15. A system, comprising:
one or more memory modules:
one or more hardware processors communicably coupled to the one or more memory modules, the one or more hardware processors configured to execute instructions stored on the one or more memory models to perform operations comprising:
obtaining historical data associated with operational suspension events corresponding to respective locations:
training a machine learning model to predict a suspension time period using a training dataset comprising the historical data associated with operational suspension events: and
predicting a suspension time period corresponding to a location using the trained machine learning model.

16. The system of claim 15, wherein the training dataset comprises historical suspension time periods labeled by respective dates and respective locations.

17. The system of claim 15, wherein the training dataset comprises historical suspension time periods and corresponding weather conditions.

18. The system of claim 15, comprising evaluating the trained machine learning model by determining a mean absolute percentage error (MAPE) of the trained machine learning model, and re-training the trained machine learning model when the MAPE satisfies a predetermined threshold.

19. The system of claim 15. comprising planning oil and gas operations based on the predicted suspension time period.

20. The system of claim 15. comprising avoiding lifting tasks in oil and gas operation planning during the predicted suspension time period.
